(19) United States
(12) Patent Application Publication
(10) Pub. No.: US 2019/0092896 A1
(43) Pub. Date: Mar. 28, 2019

(54) A CURABLE URETHANE ACRYLATE COMPOSITION WITH BIMODAL OF MOLECULAR WEIGHT DISTRIBUTION

(71) Applicant: Dow Global Technologies LLC, Midland, MI (US)

(72) Inventors: Huifeng Qian, Pearland, TX (US); Muhammad A. Shafi, Lake Jackson, TX (US); Luigi Pellacani, Carpi (IT)

(21) Appl. No.: 16/082,141

(22) PCT Filed: Feb. 27, 2017
(86) PCT No.: PCT/US2017/019695

§ 371 Date: Sep. 4, 2018

(30) Foreign Application Priority Data
Mar. 4, 2016 (IT) 102016000022845

(51) Int. Cl. C08G 18/67; C08G 18/76; C08G 18/32; C08G 18/10; C08G 18/16

(52) U.S. Cl. CPC C08G 18/672; C08G 18/7621; C08G 18/168; C08G 18/10; C08G 18/3206

(57) ABSTRACT

A curable resin composition comprising: (1) a urethane (meth)acrylate comprising a) urethane (meth)acrylate oligomers with a number average molecular weight in the range of from 400 to 1500; and b) urethane (meth)acrylate oligomers with a number average molecular weight in the range of from 1500 to 10000, present in a weight ratio of from 0.1:1 to 25:1; (2) a reactive diluent; and (3) a free radical-generating catalyst, is disclosed.

### FIELD OF INVENTION

The instant invention relates to a curable urethane acrylate composition.

### BACKGROUND OF THE INVENTION

The thermosetting resins used in composites mainly include unsaturated polyesters, vinyl esters, epoxies, phenolics, and polyurethanes. In the past few years, polyurethane resins have attracted broad interest as composite matrix materials, particularly in pultrusion processes. Compared with traditional unsaturated polyesters, vinyl esters and epoxy resins, polyurethane resin offers greater toughness, exceptional durability, and a fast cycle time. It is possible to simplify the reinforcement lay-up and reduce profile thickness by using a polyurethane matrix.

The short pot life of two-component polyurethane resins has limited their application in many composite fabrication processes. The high reactivity of two-component polyurethane resins (isocyanate+polyol) allows for the fast cycle time of processing, but also reduces the pot life of resin system, typically less than 30 minutes. In the composite fabrication processes like infusion and resin transfer molding, polyurethanes are usually limited to small composite articles because of short pot life of mixed resin and quick increases of viscosity. The glass transition temperature (Tg) of polyurethane resins needs to be increased for composite applications.

### SUMMARY OF THE INVENTION

In one broad embodiment of the present invention, there is disclosed a curable resin composition comprising, consisting of, or consisting essentially of: (1) a urethane (meth)acrylate comprising a) urethane (meth)acrylate oligomers with a number average molecular weight in the range of from 400 to 1500; and b) urethane (meth)acrylate oligomers with a number average molecular weight in the range of from 1500 to 10000, present in a weight ratio of from 0.1:1 to 25:1 (2) a reactive diluent; and (3) a free radical-generating catalyst.

In an alternative embodiment, the instant invention provides a curable resin composition, in accordance with the preceding embodiment, except that the curable resin composition further comprises an inhibitor.

In an alternative embodiment, the instant invention provides a curable resin composition, in accordance with the preceding embodiment, except that the curable resin composition comprises 10 to 90 percent by weight of the urethane (meth)acrylate, 10 to 90 percent by weight of the reactive diluent, and 0.001 to 10 percent by weight of the free radical-generating catalyst based on the total weight of the curable resin composition.

In an alternative embodiment, the instant invention provides a curable resin composition, in accordance with the preceding embodiment, except that the urethane (meth)acrylate is a reaction product of a polyisocyanate, a polyol, and a compound comprising i) a nucleophilic group and ii) a (meth)acrylate group selected from the group consisting of hydroxyethyl acrylate, hydroxypropyl acrylate, hydroxyethyl methacrylate, hydroxyethyl acrylamide, hydroxypropyl acrylamide, and mixtures thereof.

In an alternative embodiment, the instant invention provides a curable resin composition, in accordance with the preceding embodiment, except that the reactive diluent is selected from the group consisting of vinyl toluene, divinyl benzene, methyl methacrylate, tert-butyl methacrylate, iso-butyl methacrylate, hydroxyethyl acrylate, hydroxypropyl acrylate, hydroxyethyl methacrylate, hydroxyethyl acrylamide, hydroxypropyl acrylamide, 1,4-butanediol diacrylate (BDDA), 1,6-hexanediol diacrylate (HDDA), diethylene glycol diacrylate, 1,3-butylene glycol diacrylate, neopentyl glycol diacrylate, cyclohexane dimethanol diacrylate, dipropylene glycol diacrylate, tripropylene glycol diacrylate, ethoxylated bisphenol A diacrylate, trimethylolpropane triacrylate, pentaerythritol triacrylate, pentaerythritol tetraacrylate, and mixtures thereof.

In an alternative embodiment, the instant invention provides a curable resin composition, in accordance with the preceding embodiment, except that the free radical-generating catalyst is selected from the group consisting of tert-Butyl peroxyneodecanoate, benzoyl peroxide, dicumyl peroxide, methyl ethyl ketone peroxide, lauryl peroxide, cyclohexanone peroxide, t-butyl perbenzoate, t-butyl hydroperoxide, t-butylbenzene hydroperoxide, cumene hydroperoxide, t-butyl peroctoate, azobis-isobutyronitrile, 2-t-butylazo-2-cyano-4-methylpentane, and 4-t-butylazo-4-cyano-valeric acid.

In an alternative embodiment, the instant invention provides a curable resin composition, in accordance with the preceding embodiment, except that the inhibitor is selected from the group consisting of (2,2,6,6-Tetramethylpiperidin-1-yl)oxyl (TEMPO), mono methyl ether of hydroquinone (MEHQ), dihydroxybenzenes, benzoquinones, hindered phenols, and hindered phenols based on triazine derivatives.

In an alternative embodiment, the instant invention provides a curable resin composition, in accordance with the preceding embodiment, with the curable resin composition having a glass transition temperature above 75° C.

In an alternative embodiment, the instant invention provides a filament winding process, a pultrusion process, and a cured-in-place pipe process incorporating the curable resin composition of the above-described embodiments.

In an alternative embodiment, the instant invention provides a cured article comprising a composite, a coating, an adhesive, an ink, an encapsulation, or a casting prepared from the curable resin composition of the above-described embodiments.

### DETAILED DESCRIPTION OF THE INVENTION

The instant invention is a curable resin composition. The instant invention is a curable resin composition comprising: (1) a urethane (meth)acrylate comprising a) urethane (meth)acrylate oligomers with a number average molecular weight in the range of from 400 to 1500; and b) urethane (meth)acrylate oligomers with a number average molecular weight in the range of from 1500 to 10000, present in a weight ratio of from 0.1:1 to 25:1; (2) a reactive diluent; and (3) a free radical-generating catalyst.

The urethane (meth)acrylate can be synthesized through the reaction of polyisocyanates, polyols, and a compound containing both a nucleophilic group and a (meth)acrylate group.

The polyisocyanates used are typically aromatic, aliphatic, and cycloaliphatic polyisocyanates with a number average molar mass below 800 g/mol. Examples of diisocyanates include but are not limited to toluene 2,4-/2,6-diisocyanate (TDI), methylenediphenyl diisocyanate (MDI), triisocyanatononane (TIN), naphthyl diisocyanate (NDI), 4,4′-diisocyanatodicyclohexylmethane, 3-isocyanatomethyl-3,3,5-trimethylcyclohexyl isocyanate (isophorone diisocyanate, IIPDI), tetramethylene diisocyanate, hexamethylene diisocyanate (HDI), 2-methylpentamethylene diisocyanate, 2,2,4-trimethylhexamethylene diisocyanate (THDI), dodecamethylene diisocyanate, 1,4-diisocyanatocyclohexane, 4,4′-diisocyanato-3,3′-dimethyldicyclohexylmethane, 4,4′-diisocyanato-2,2-dicyclohexylpropane, 3-isocyanatomethyl-1-methyl-1-isocyanatocyclohexane (MCI), 1,3-diisooctylcyanato-4-methylcyclohexane, 1,3-diisocyanato-2-methylcyclohexane, and also mixtures thereof.

The polyols used can include polyols of various chain lengths in relation to the desired performance level of the resulting polymer. This also includes combinations of polyols that include at least two polyalkylene glycols having different equivalent weights, wherein the short-chain equivalent weight is from 50 to 300 and the long chain equivalent weight is above 1000. The polyol can be selected from polyether polyols and polyester polyols. Generally, the polyols have a functionality of 2.0 or greater. Examples of polyether polyols include Voranol 8000LM, Voranol 4000LM, Polyglycol P2000, Voranol 1010L, Polyglycol P425, TPG, Voranol 230-660 and mixtures thereof. Also included are polyester polyols such as those available from Stepan Company under the trademark Stepanpol, or those available from COIM under the trademarks Isoexter and Diexter, or those available from Invista under the trademark Terate.

The polyurethane with free terminal isocyanate groups is capped with a compound containing a nucleophilic group (eg. hydroxyl, amino, or mercapto) and ethylenically unsaturated functionalities derived from (meth)acrylate. Preferred examples include 2-hydroxyethyl acrylate (HEA), 2-hydroxypropyl acrylate (HPA), 2-hydroxyethyl methacrylate (HEMA), 2-hydroxypropyl methacrylate (HPMA), and mixtures thereof.

Urethane (meth)acrylates utilized in this are prepared by two-step reactions. In the first step, the polyurethane oligomers are prepared by reacting an organic diisocyanate with a polyol in an equivalent ratio of NCO:OH from 1.4:1 to 3.0:1, using standard procedures, to yield an isocyanate-terminated prepolymer with controlled molecular weight. Any and all ranges between 1.4:1 and 3.0:1 are included herein and disclosed herein, for example, the NCO/OH ratio can range from about 1.4:1 to about 2.3:1. In the second step, polyurethane oligomers with free terminal isocyanate groups are capped with a compound containing the nucleophilic group (e.g. hydroxyl, amino or mercapto) and ethylenically unsaturated functionalities derived from (meth)acrylate by using methods well-known in the art, such as, for example, the methods disclosed in US 2001/0031838. The percent of free NCO in the final urethane acrylate is generally in the range of from 0 to 0.1 percent. Any and all ranges between 0 and 0.1 percent are included herein and disclosed herein, for example, the percent of free NCO in the final urethane acrylate can be in the range of from 0 to 0.001%. Alternatively, the so called “reverse process” can be used, in which the isocyanate is reacted first with the hydroxyl acrylate, and then with the polyols.

In some embodiments, a urethane catalyst can be used to accelerate the reaction. Examples of urethane catalysts include, but are not limited to tertiary amines and metal compounds such as stannous octoate and dibutyltin dilaurate. The urethane catalyst is preferably employed in an amount in the range of from 50 to 400 ppm based on the total weight of the reactants.

Commercially available urethane (meth)acrylates can also be used. These include, but are not limited to urethane (meth)acrylates including CN 1963, CN9167, CN 945A60, CN 945A70 CN 944B85, CN 945B85, CN 934, CN 934X50, CN 966A80, CN 966H90, CN 966J75, CN 968, CN 981, CN 981A75, CN 981B88, CN 982A75, CN 982B88, CN 982E75, CN 982P90, CN 983B88, CN 985B88, CN 970A60, CN 970E60, CN 971A80, CN 972, CN 973A80, CN 977C70, CN 975, CN 978, all available from Sartomer. Mixtures thereof can also be used.

Another example of a urethane (meth)acrylate obtainable from commercial sources is 4000LM urethane (meth)acrylate available from The Dow Chemical Company.

The weight ratio of low number average molecular weight urethane (meth)acrylate (400-1500) and high number average molecular weight urethane (meth)acrylate (1500-10,000) generally ranges from 0.1:1 to 25:1. All individual values and subranges from 0.1:1 to 25:1 are included herein and disclosed herein; for example, the weight ratio of low number average molecular weight urethane (meth)acrylate and high number average molecular weight urethane (meth)acrylate can be from 0.2:1 to 20:1; or in the alternative, the weight ratio of low number average molecular weight urethane (meth)acrylate and high number average molecular weight urethane (meth)acrylate can be from 1:10 to 10:1.

The curable resin composition may comprise 1 to 99 percent by weight of urethane (meth)acrylate. All individual values and subranges from 1 to 99 weight percent are included herein and disclosed herein; for example, the curable resin composition may comprise 10 to 90 percent by weight of urethane (meth)acrylate; or in the alternative, the curable resin composition may comprise 30 to 80 percent by weight of urethane (meth)acrylate; or in the alternative, the curable resin composition may comprise 40 to 65 percent by weight of urethane (meth)acrylate.

The reactive diluent is a liquid reaction medium containing at least one ethylenic double bond. The reactive diluent is curable by polymerization in the presence of a free radical-generating catalyst. Examples of such reactive diluents are vinyl toluene, divinyl benzene and (meth)acrylates such as methyl methacrylate, tert-butyl methacrylate, iso-butyl methacrylate, hydroxyethyl acrylate, hydroxypropyl acrylate, hydroxyethyl methacrylate, hydroxyethyl acrylamide, hydroxypropyl acrylamide, and mixtures thereof. Other reactive diluents that can be used are glycols and/or polyether polyols with terminal acrylate or methacrylate groups, thus carrying two or more ethylenic double bonds: thus preferred diluents include 1,4-butanediol diacrylate (BDDA), 1,6-hexanediol diacrylate (HDDA), diethylene glycol diacrylate, 1,3-butylene glycol diacrylate, neopentyl glycol diacrylate, cyclohexane dimethanol diacrylate, dipropylene glycol diacrylate, tripropylene glycol diacrylate, ethoxylated bisphenol A diacrylate, trimethylolpropane triacrylate, pentaerythritol triacrylate, pentaerythritol tetraacrylate, their corresponding methacrylate analogues, and all other related derivatives. Mixtures of any of the reactive diluents above can also be used.

The curable resin composition may comprise 1 to 99 percent by weight of reactive diluents. All individual values and subranges from 1 to 99 weight percent are included herein and disclosed herein; for example, the curable resin composition may comprise 10 to 90 percent by weight of reactive diluent; or in the alternative, the curable resin composition may comprise 35 to 60 percent by weight of reactive diluent.

In various embodiments, the curable composition further comprises a free radical-generating catalyst. Suitable free radical-generating catalysts include peroxide or azo type compounds. The preferred peroxide catalysts include organo peroxides and hydroperoxides such as tert-Butyl peroxyneodecanoate, benzoyl peroxide, dicumyl peroxide, methyl ethyl ketone peroxide, lauryl peroxide, cyclohexanone peroxide, t-butyl perbenzoate, t-butyl hydroperoxide, t-butylbenzene hydroperoxide, cumene hydroperoxide, t-butyl peroctoate, and the like. The preferred azo compounds include azobis-isobutyronitrile, 2-t-butylazo-2-cyano-4-methylpentane, and 4-t-butylazo-4-cyano-valeric acid.

The curable resin composition may comprise from 0.001 to 10 percent by weight of a free radical-generating catalyst. All individual values and subranges from 0.001 to 10 weight percent are included herein and disclosed herein; for example, the curable resin composition may comprise 0.05 to 2 percent by weight of free radical-generating catalyst; or in the alternative, the curable resin composition may comprise 0.1 to 1 percent by weight of free radical-generating catalyst.

In various embodiments, the curable composition further comprises an inhibitor to avoid free radical polymerization of the (meth)acrylates. Suitable inhibitors include, but are not limited to (2,2,6,6-Tetramethylpiperidin-1-yl)oxyl (TEMPO), mono methyl ether of hydroquinone (MEHQ), dihydroxybenzenes, benzoquinones, hindered phenols, and hindered phenols based on triazine derivatives.

The inhibitor is generally present in the curable resin composition in the range of from 50 to 1000 ppm by weight. For example, the curable resin composition may comprise 50 to 100 ppm by weight of inhibitor or in the alternative, the curable resin composition may comprise 100-200 ppm by weight of inhibitor.

The curable resin composition may include other ingredients, such as activators: these are metal carboxylates capable of increasing the effectiveness of the free radical-generating catalyst, consequently improving the degree of polymerization of the curable resin. Examples of activators include metal carboxylates, and cobalt salts such as cobalt naphtenate, and they may be used at a level of about 0.01 to 1% by weight of the curable resin composition. Accelerators represent another ingredient that can effectively increase the speed and completeness of the radical polymerization of the curable resin. The accelerator may be selected from the group of anilines, amines, amides, pyridines, and combinations thereof. Another example of an accelerator, not selected from the group of anilines, amines, amides, and pyridines is acetylacetone. In various embodiments, the accelerator, if included, includes a dimethyl toluidine or a dialkyl aniline. In various other embodiments, the accelerator, if included, includes N,N-dimethyl-p-toluidine, N,N-diethylaniline, N,N-dimethylaniline, and combinations thereof. If present, the accelerator is generally present in an amount of from 0.01 to 0.5 by weight of the curable resin composition. The curable resin composition may also include a gel time retarder. The addition of a gel time retarder decreases the gel time of the urethane acrylate composition. If included, the gel time retarder is generally selected from the group of diones, naphthenates, styrenes, and combinations thereof. In various embodiments, if included, the gel time retarder includes 2,4-pentanedione. In various other embodiments, if included, the gel time retarder is included in an amount of from 0.01 to 0.3 by weight of the resin system.

It should be noted that the free radical catalyst system, namely the peroxides or azo compounds plus the other ingredients directly associated with the speed of radical polymerization (activators, accelerators, retarders) are preferably added to the rest of the curable resin, comprising the urethane acrylate and the reactive diluent, preferably shortly before the curable resin undergoes polymerization: in fact the free radical-generating catalyst system may have a negative impact on the storage stability of the curable resin.

Other ingredients may be also included in the curable resin, some of these preferably shortly before the curable resin undergoes polymerization, to avoid possible negative impact on the storage stability of the curable resin. Thus, internal mold release agents may be included to facilitate the release of the polymerized composite article from the mold in which it has been prepared: the amount may range from about 0.1% to about 5% by weight of the curable resin composition, and examples of suitable products are the internal mold release agents for composite applications available from Axel or from Wurtz.

Other types of ingredients that may be included in the curable resin are fillers, which may be used for a number of different reasons, such as to provide pigmentation, flame retardance, insulation, thixotropicity, aid with dimensional stability and physical properties, and reduced cost of the composite structure. Suitable fillers for the urethane acrylate layer include reactive and non-reactive conventional organic and inorganic fillers. Examples include, but are not limited to, inorganic fillers, such as calcium carbonate, silicate minerals, for example, both hollow and solid glass beads, phyllosilicates such as antigorite, serpentine, hornblends, amphiboles, chrysotile, and talc; metal oxides and hydroxides, such as aluminum oxides, aluminium hydroxide, titanium oxides and iron oxides; metal salts, such as chalk, barite and inorganic pigments, such as cadmium sulfide, zinc sulfide and glass, inter alia; kaolin (china clay), and aluminum silicate and co-precipitates of barium sulfate and aluminum silicate. Examples of suitable organic fillers include, but are not limited to, carbon black and melamine Thixotropic agents that are useful in this invention include fumed silica, organoclays, inorganic clays and precipitated silica. The amount of filler used for the purposes of this invention, will depend of the type of filler and reason for its presence in the system: thus, the thixotropic agents are often used at levels of up to about 2 percent by weight, while fillers that have a flame retardant action such as aluminium hydroxide, may be used in much larger amounts, in an amount that is in fact comparable or even larger than the amount of curable resin, comprising the urethane acrylate plus the reactive diluent.

Other additives having specific functions, as known in the industry, may also be included in the curable resin composition: examples include but are not limited to, air release agents, adhesion promoters, leveling agents, wetting agents, UV absorbers and light stabilizers.

In the production of the curable resin composition, the method for producing such a composition includes blending or mixing urethane (meth)acrylates, reactive diluents and a free radical-generating catalyst at temperature from 10° C. to 40° C. In another embodiment, the method includes blending or mixing urethane (meth)acrylates and reactive diluents first for long time storage (generally more than one month) and then adding the free radical-generating catalyst.

The polymerization and curing of the urethane acrylate resin is effected, using well-known procedures in the art, preferably in the presence of a polymerization catalyst. The resin composition may be thermal cured or light cured. As for thermal curing, the curing temperature is dependent on the particular catalyst utilized. In one embodiment, the curable resin composition can be cured from 25° C. to 200° C., and in another embodiment, the curable resin composition can be cured from 70° C. to 150° C. As for light curing, the light source is dependent on the particular photoinitiator catalyst used. The light source can be visible light or UV light.

The urethane acrylate with long pot life is suitable for various composition fabrication processes like pultrusion, filament winding, RTM, infusion, and cured-in-place pipe. A cured article prepared from the curable resin composition can be used to produce composites, coatings, adhesives, inks, encapsulations, or castings. The composites can be used in applications such as, for example, wind turbines, boat hulls, truck bed covers, automobile trim and exterior panels, pipe, tanks, window liners, seawalls, composite ladders and the like.

### EXAMPLES

The present invention will now be explained in further detail by showing Inventive Examples, and Comparative Examples, but the scope of the present invention is not, of course, limited to these Examples.

Chemicals

4000LM UA was prepared by reacting Voranol 4000LM with TDI and then capping with HEA. ROCRYL™ 420 Hydroxyethyl Acrylate (HEA), ROCRYL™400 Hydroxyethyl methacrylate (HEMA), and ROCYRL™410 Hydroxypropyl Methacrylate (HPMA) are available from The Dow Chemical Company.

Voranate T-80, Voranol 8000LM, Voranol 4000LM, Polyglycol P425, TPG, Vornaol 230-660 are available from The Dow Chemical Company.

Trigonox 23-75c (tert-Butyl peroxyneodecanoate) available from AkzoNobel.

Urethane acrylates CN985B88, CN9167US, CN945A70 available from Sartomer.

The product information and properties of the urethane acrylates are listed in Table 1.

TABLE 1
Product information and properties of Sartomer urethane acrylates

| | | | | | | Tensile | |
|---|---|---|---|---|---|---|---|
| | | | Viscosity | Tg ° C. | Elongation | Strength | Modulus |
| Sartomer Urethane Acrylate | | Functionality | at 60 C. | (by DSC) | (%) | (MPa) | (MPa) |
| CN985B88* | Aliphatic urethane | 2 | 205 | 103 | 5 | 52 | 2378 |
| | acrylate blended | | | | | | |
| | with SR238 | | | | | | |
| CN9167US | Aromatic | 2 | 700 | 62 | 3 | 30 | 772 |
| | urethane acrylate | | | | | | |
| CN945A70 | Aliphatic urethane | 3 | 2200 | 97 by DMA | 8 | 59 | 1379 |
| | acrylate blended | | | | | | |
| | with SR306 | | | | | | |

*Mn of CN985B88 from GPC includes 461 (41%), 319 (37.83%), 174 (7.57%). Mn of CN9167US from GPC includes 1442 (11%), 929 (30%), 574 (8.5%), 501 (9%), 446 (17.8%), 383 (20%. Mn of CN945A70 includes 1978 (13.9%), 1214 (30.7%), 926 (10.4%), 467 (11.8%), 276 (14%).

Procedures

1. Plaque Preparation of Urethane Acrylate

The molds were made from “U”-shaped, ⅛ inch thick aluminum spacers positioned between two sheets of Duo-foil aluminum and compressed between two thick heavy metal plates. The Duo-foil aluminum sheets were coated with a proprietary release agent. A rubber tubing was used for gasket material following the inside dimensions of the spacer. Once assembled, the mold was clamped together with large C-clamps. The open end of the “U”-shaped spacer faced upward, and the duo-foil extended to the edge of the metal plates. The top edge of the Duo-foil was higher than the edge of the metal plates and was bent for the filling of the reaction mixture. The plaque was cured at 100° C. for 1-2 hr.

2. Dynamic Mechanical Thermal Analysis

Glass transition temperature (Tg) was determined by Dynamic Mechanical Thermal Analysis (DMTA), using a TA Instruments Rheometer (Model: ARES).

Rectangular samples (around 6.35 cm×1.27 cm×0.32 cm) were placed in solid state fixtures and subjected to an oscillating torsional load. The samples were thermally ramped from about −60° C. to about 200° C. at a rate of 3° C./minute and 1 Hertz (Hz) frequency.

### RESULTS AND DISCUSSIONS

TABLE 2
Examples of Curable Urethane Acrylate Resin Compositions

| | | Comp. | Comp. | Comp. | Comp. | Inventive | Inventive | Inventive |
|---|---|---|---|---|---|---|---|---|
| Component | Composition | Example 1 | Example 2 | Example 3 | Example 4 | Example 1 | Example 2 | Example 3 |
| High MW | 4000LM UA | 75 | | | | 20 | 20 | 20 |
| UA | | | | | | | | |
| Low MW | Sartomer | | 70 | | | 50 | | |
| UAs | CN985B88 | | | | | | | |
| | Sartomer | | | 60 | | | 50 | |
| | CN9167US | | | | | | | |
| | Sartomer | | | | 70 | | | 50 |
| | CN945A70 | | | | | | | |
| Reactive | HEA | 24 | | | | | | |
| Diluents | HEMA | | 29 | 39 | 29 | 29 | 29 | 29 |
| Free | TRIGONOX | 1 | 1 | 1 | 1 | 1 | 1 | 1 |
| radical- | 23-C75 | | | | | | | |
| generating | | | | | | | | |
| catalyst | | | | | | | | |
| | Total, gram | 100 | 100 | 100 | 100 | 100 | 100 | 100 |
| | Tg* | 18° C. | 132° C. | 70° C. | 70° C. | 137° C. | 80° C. | 86° C. |
| | (Tan_Delta | | | | | | | |
| | peak) | | | | | | | |

*Here, only high Tg of cured mixture is reported. The low Tg containing 4000LM UA are between −40 to −60° C.

Table 2 shows Examples of curable urethane acrylate resin composition. The resin compositions were prepared by mixing high MW UAs (e.g. 4000LM UA), low MW UAs (e.g. Sartomer CN985B88, CN9167US, or CN945A70), reactive diluents (HEA, HEMA) and a free radical-generating catalyst (TRIGONOX 23-C75) at 2000 rpm for 2 minutes by using Flacktek SpeedMixers. Then plaques of the resin compositions were prepared according to the method reported in the ‘Procedures’ section, above. Glass transition temperature (Tg) of the cured mixture was measured by Dynamic Mechanical Thermal Analysis (DMTA).

In Table 2, only high Tg of the cured mixture is reported for clarity. The low Tgs containing high MW UAs like 4000LM UA are between −40 to −60° C. Herein, Comparative Example 1 only containing high MW urethane acrylate (4000LM UA) shows a Tg of 18° C. Comparative Example 2 containing low MW UA (CN985B88) shows a Tg of 132° C. When the resin composition comprises both 4000LM UA and CN985B88 (Inventive Example 1), the Tg of cured mixture is up to 137° C., which is 119° C. and 5° C. higher than Comparative Example 1 and Comparative Example 2.

TABLE 3
Examples of Curable Urethane Acrylate Resin Compositions

| | | | Comparative | Inventive |
|---|---|---|---|---|
| Component | Compositions | Mn | Example 5 | Example 4 |
| High MW UA | 4000LM UA | 17,310 (47.1%) | | 11.1 |
| | | 9,050 (27.4%) | | |
| | | 4,280 (19.1%) | | |
| | | 432 (5.9%)* | | |
| Low MW UAs | TDI | 174.2 | 22.09 | 22.09 |
| | P425 | 425 | 6.95 | 6.95 |
| | TPG | 192 | 14.28 | 14.28 |
| | HPMA | 144.2 | 12.49 | 12.49 |
| Reactive Diluents | Vinyl toluene | 118.2 | 31.98 | 31.98 |
| | HEMA | 130.1 | 12.21 | 12.21 |
| Radical Initiator | Trigonox 23-75c | | 1 | 1.1 |
| | Total, gram | | 101 | 112.2 |
| | Tg (Tan_Delta) | | 76.5° C. | 81° C. |

*Mn of 4000LM UA is obtained from GPC analysis.

Table 3 lists two more examples of curable urethane acrylate resin compositions. Herein, low molecular weight UAs are prepared by reacting organic diisocyanate (TDI) with a polyol (Polyglycol P425, tripropylene glycol) in step 1 and then capping the isocyanate-terminated urethane oligomer with hydroxyl ethyl methacrylate (HEMA) in step 2. The polyols used to prepare low MW UAs are Polyglyco P425 (MW˜425), and tripropylene glycol (TPG, MW=192). Comparative Example 5 only contains low molecular weight UA, which shows a Tg of 76.5° C. Meanwhile, Inventive Example 4, which is composed of both low and high molecular weight UAs, shows a Tg of 81° C.

1. A curable resin composition comprising:
(1) a urethane (meth)acrylate comprising
a) urethane (meth)acrylate oligomers with a number average molecular weight in the range of from 400 to 1500; and
b) urethane (meth)acrylate oligomers with a number average molecular weight in the range of from 1500 to 10000, present in a weight ratio of from 0.1:1 to 25:1;
(2) a reactive diluent; and
(3) a free radical-generating catalyst.

2. The curable resin composition according to claim 1, further comprising an inhibitor.

3. The curable resin composition according to claim 1, wherein said curable resin composition comprises 10 to 90 percent by weight of said urethane (meth)acrylate, 10 to 90 percent by weight of said reactive diluent, and 0.001 to 10 percent by weight of said free radical-generating catalyst based on the total weight of the curable resin composition.

4. The curable resin composition according to claim 1, wherein said urethane (meth)acrylate is a reaction product of a polyisocyanate, a polyol, and a compound comprising i) a nucleophilic group and ii) a (meth)acrylate group selected from the group consisting of hydroxyethyl acrylate, hydroxypropyl acrylate, hydroxyethyl methacrylate, hydroxyethyl acrylamide, hydroxypropyl acrylamide, and mixtures thereof.

5. The curable resin composition according to claim 1, wherein the reactive diluent is selected from the group consisting of vinyl toluene, divinyl benzene, methyl methacrylate, tert-butyl methacrylate, iso-butyl methacrylate, hydroxyethyl acrylate, hydroxypropyl acrylate, hydroxyethyl methacrylate, hydroxyethyl acrylamide, hydroxypropyl acrylamide, 1,4-butanediol diacrylate (BDDA), 1,6-hexanediol diacrylate (HDDA), diethylene glycol diacrylate, 1,3-butylene glycol diacrylate, neopentyl glycol diacrylate, cyclohexane dimethanol diacrylate, dipropylene glycol diacrylate, tripropylene glycol diacrylate, ethoxylated bisphenol A diacrylate, trimethylolpropane triacrylate, pentaerythritol triacrylate, pentaerythritol tetraacrylate, and mixtures thereof.

6. The curable resin composition according to claim 1, wherein said free radical-generating catalyst is selected from the group consisting of tert-Butyl peroxyneodecanoate, benzoyl peroxide, dicumyl peroxide, methyl ethyl ketone peroxide, lauryl peroxide, cyclohexanone peroxide, t-butyl perbenzoate, t-butyl hydroperoxide, t-butylbenzene hydroperoxide, cumene hydroperoxide, t-butyl peroctoate, azobis-isobutyronitrile, 2-t-butylazo-2-cyano-4-methylpentane, and 4-t-butylazo-4-cyano-valeric acid.

7. The curable resin composition according to claim 1, wherein said inhibitor is selected from the group consisting of (2,2,6,6-Tetramethylpiperidin-1-yl)oxyl (TEMPO), mono methyl ether of hydroquinone (MEHQ), dihydroxybenzenes, benzoquinones, hindered phenols, and hindered phenols based on triazine derivatives.

8. The curable resin composition according to claim 1, having a glass transition temperature above 75° C.

9. A filament winding process incorporating the curable resin composition of claim 1.

10. A pultrusion process incorporating the curable resin composition of claim 1.

11. A cured-in-place pipe process incorporating the curable resin composition of claim 1.

12. An infusion process incorporating the curable resin composition of claim 1.

13. A cured article comprising a composite, a coating, an adhesive, an ink, an encapsulation, or a casting prepared from the curable resin composition of claim 1.
